(19) United States
(12) Patent Application Publication
(10) Pub. No.: US 2009/0256708 A1
(43) Pub. Date: Oct. 15, 2009

(54) SYSTEM AND METHOD OF RFID WIRELESS CONTROL

(76) Inventors: JUE-HSUAN HSIAO, TAIPEI COUNTY (TW); YI-HUA CHEN, TAIPEI HSIEN (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/102,216

(22) Filed: Apr. 14, 2008

(51) Int. Cl. G08B 13/22

(52) U.S. Cl. 340/572.1

(57) ABSTRACT

A system of RFID wireless control comprises: at least one electronic device having an RFID tag and a receiver, and a controller having a reader for reading and recording the RFID tag of the at least one electronic device to form a list of electronic devices. The electronic device to be controlled is selected from the list, and the controller transmits or receives signals to or from the selected electronic device. The present invention also discloses a method of RFID wireless control for an RFID system.

### BACKGROUND OF THE INVENTION

1. Field of the Invention

The present invention relates to a system and method of wireless control. In particular, the present invention relates to a system and method of wireless control using radio frequency identification (RFID).

2. Description of the Prior Art

Nowadays some home appliances powered by electricity use a control loop placed in pre-installed underground conduits when a building and a mechanical “ON/OFF” switch, for example, fixed lighting and the like, are constructed. The method of control using pre-installed conduits has shortcomings: it requires locations and numbers of fixed switches. Once conduits are installed firmly, it is difficult to add extra switches, change locations, or even carry out the function of remote control with original conduits. If extra fixed lighting is to be added, it can be implemented by open conduits, which ruin the appearance of the building, or by underground conduits (or decoration), which increases the difficulty and cost of construction.

Some home appliances use sockets at the end of pre-installed underground conduits when a building, and control “ON” or “OFF” by switches, for example, electric fan, electric rice cooker and the like. It is difficult for home appliances with plugs plugging into sockets at the end of pre-installed underground conduits to carry out a secure and reliable function of remote control under the original conduit scheme because there are various types of home appliances and no universal method for identifying home appliances is applied. Some home appliances use an infrared remote controller to solely control “ON,” “OFF” or other functions, for example, television and the like. The infrared remote controller is directed to certain appliances, it is difficult to use it with other appliances and perform the function of centralized remote control. Some home appliances use radio frequency remote controller to solely control “ON,” “OFF” or other functions, for example, air conditioners and the like. However, this type of radio frequency remote controller may also cause false control because no method for identifying each appliance is applied (for example, due to poorness of wooden bays or compartments, the remote controller of room A may control both split-system air conditioners of rooms A and B).

Additionally, a technology not commonly applied is power line communication control technology. Appliance labels and control signals are modulated and carried onto power lines with 60/50 Hz, and transmitted to achieve control. However, because, no universal method for identification is applied, false control may be caused (for example, due to the same settings for identifications of appliances, the remote controller may control both split-system air conditioners of rooms A and B).

Accordingly, wireless control system using RFID can be used to solve the above problems of identification of control for traditional appliances or other types of devices.

### SUMMARY OF THE INVENTION

A wireless remote control system of the present invention mainly uses a universal unique product labeling technique (for example, RFID) as device identification codes for respective identification of control for appliances or apparatuses. The RFID method for identification is universally unique (no duplicate), and identification codes can be read easily and conveniently under no-contact operation.

According to an embodiment of the present invention, a system of RFID control comprises at least one electronic device having an RFID tag associated with an RFID tag code, and a first transceiver; and a controller, mainly including a second transceiver and a reader for reading and recording the RFID tag of the electronic device to form a list of electronic devices. The controller selects an electronic device to be controlled from the list, and transmits and receives signals with the RFID tag code to and from the electronic device.

According to another embodiment of the present invention, a control system further comprises a fixed specified control unit matching the RFID tag for controlling the electronic device.

According to another embodiment of the present invention, a method of RFID wireless control applies to an RFID system that comprises at least one electronic device having an RFID tag associated with an RFID tag code, and a first transceiver, and a controller, said method comprising: reading and recording an RFID tag with a reader of the controller; forming a list of electronic devices in the controller; selecting the electronic device to be controlled from the list; transmitting signals with the RFID tag code to the electronic device to control the electronic device.

According to a wireless control system of the present invention, each electronic device can be one-to-one controlled through the specified control unit, while the electronic devices can be one-to-many controlled by the controller. Thus, construction of a huge and complex conduit system of mechanical switches can be avoided, so as to save time and costs. Meanwhile, if extra electronic devices are added, the present invention can also save a rearrangement of the conduit system which ruins the appearance of the building or causes inconvenience in daily life; an additional cost for decoration required for cover the system.

A wireless control system of the present invention can transmit radio waves for communication on the industrial, scientific and medical (ISM) bands, and hence it has the advantage of better electromagnetic penetration, so that the locations of the electronic devices, the specified control unit and the controller are more flexible, and this makes it easier to carry out control.

According to a wireless control system of the present invention, the electronic device further comprises a bypass switch loop or a parallel switch control compatible with a current conduit system, so as to manually control the electronic devices when the remote control is out of order.

The wireless control system or method of the present invention can be used to construct a remote control system for common home appliances to facilitate daily life of disabled or elderly persons. The present invention also allows schools, organizations or malls to quickly construct a remote control system for illumination and power. Besides facilitating centralized control and construction maintenance, it can further utilize a programmable control procedure function, so that the system is more secure in use.

### BRIEF DESCRIPTION OF THE DRAWINGS

FIG. 1 is a diagram of the connecting relationship between an electronic device and a transceiver, according to an embodiment of the present invention;

FIG. 2 is a structure block diagram of a controller according to an embodiment of the present invention;

FIG. 3 is a structure block diagram of a specified control unit according to an embodiment of the present invention;

FIG. 4 is a structure block diagram of an electronic device according to the first embodiment of the present invention;

FIG. 5 illustrates a wireless control system according to an embodiment of the present invention.

### DETAILED DESCRIPTION

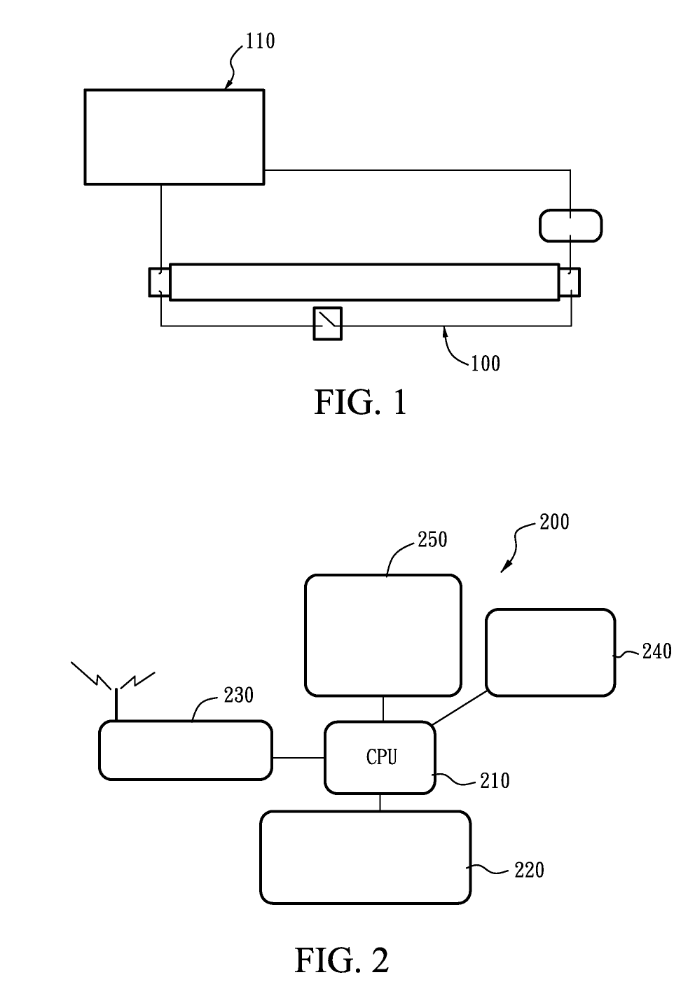

FIG. 1 is a diagram of the connecting relationship between an electronic device 100 and a transceiver 110, according to an embodiment of the present invention, wherein the electronic device 100 is a lamp in the embodiment. The electronic device 100 has an RFID tag (not shown) and a transceiver 110, and the transceiver 110 is connected with the electronic device 100. Because the electronic device 100 has a unique RFID tag associated with an RFID tag code, the transceiver 110 only receives or transmits signals with the RFID tag code. The electronic device 100 can also connect a switch control in parallel or arrange a bypass switch loop (not shown), which is compatible with existing underground conduits or open conduits, so as to manually control the electronic device 100; thus, the electronic device is more secure and maintenance is carried out conveniently as well.

FIG. 2 is a structure block diagram of a controller 200. The controller 200 comprises a central processor unit 210, a memory 220, a transceiver 230 and a reader 240. The reader 240 reads the RFID tag of the electronic device and records it in the memory 220, and this is processed by the central processor unit 210 to form a list of the electronic devices. The controller 200 selects an electronic device to be controlled from the list, transmits to or receives from the selected electronic device and thereby wirelessly controls the electronic device. The controller 200 further comprises a display 250, and the display can be a liquid crystal display for displaying the list of the electronic devices. The list of the electronic devices can also be a graphical interface displayed on the display 250. Meanwhile, the controller comprises a programmable control procedure function, and thus it can control the electronic device more efficiently.

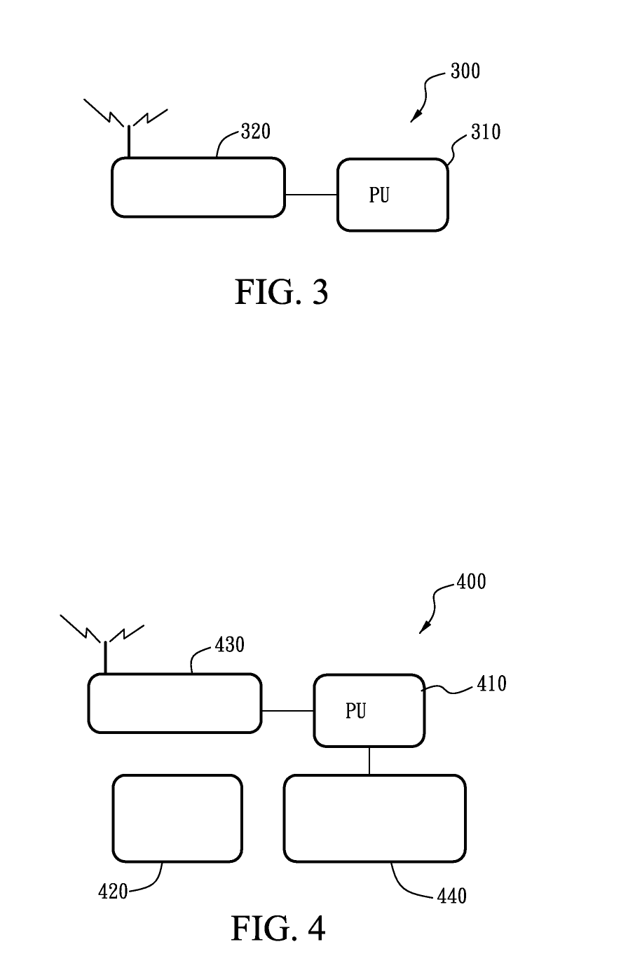

FIG. 3 is a structure block diagram of a specified control unit 300. The control unit 300 is an optional accessory, i.e., the specified control unit can be included in the electronic device or left out. Further, the specified control unit is usually a fixed type, i.e., a location is selected, for example, on the wall, and the specified control unit is fixed to the location. The specified control unit comprises a processing unit 310 and a transceiver 320. The specified control unit 300 further comprises the RFID tag associated with the RFID tag code, matching the electronic device, wherein the RFID tag code is processed by the processor unit 310 and the transceiver 320 specifically transmits signals to or receives signals with the RFID tag code from the matching electronic device. The specified control unit 300 further comprises at least one sensor (not shown) for sensing ambient environmental factors (for example, infrared or temperature) to automatically control the electronic device on the basis of the environmental factors.

FIG. 4 is further a structure block diagram of an electronic device 400. The electronic device comprises a processor unit 410, an RFID tag 420 and a transceiver 430. The electronic device 400 can be identified by the RFID tag 420 of the electronic device. The electronic device 400 further comprises a wireless control solid state relay switch 440 to control the electronic device 400.

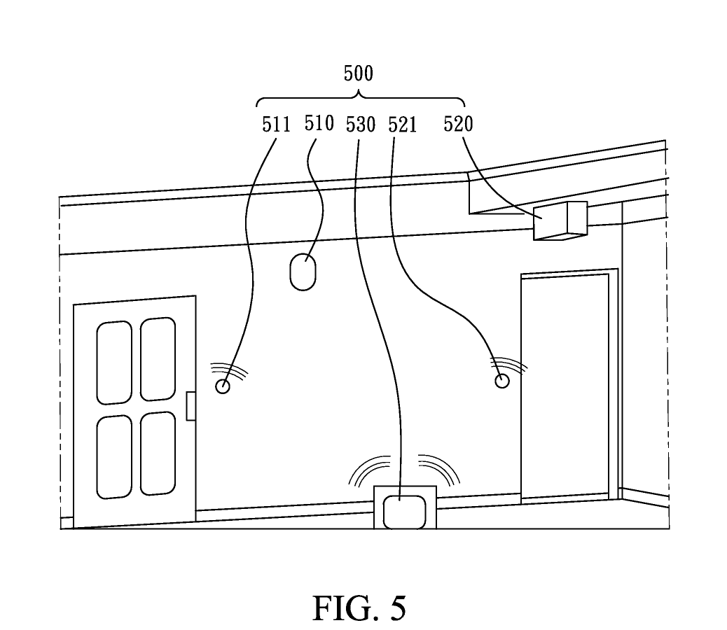

FIG. 5 illustrates a wireless control system 500, according to an embodiment of the present invention. The wireless control system 500 has 2 electronic devices (510, 520); each of the electronic devices (510, 520) comprises an RFID tag associated with an RFID tag code, and a transceiver (not shown); a specified control unit (511, 521) is arranged for and matches each of the electronic devices arrange each electronic device (510, 520); and the system has a controller 530 with a reader (not shown). As shown in FIG. 5, the electronic devices (510, 520) are lamps. However, the electronic devices can be any electronic devices controlling states by electricity. The transceiver of the electronic devices transmits and receives signals with the RFID tag code. The specified control units (511, 521) of the electronic devices, with the matching RFID tag code of each electronic device, specially transmit or receive signals with the RFID tag code of the electronic devices (510, 520). The locations of the specified control units (511, 521) can be selected so that they are around the electronic devices and within the range for receiving or transmitting signals, and then the specified control units are installed fixedly, that is, the specified control units are installed in the locations selected according to convenience of operation or terrain. Firstly, the reader of the controller 530 reads and records one of the RFID tag codes of the electronic devices (510, 520), and reads and records another of the RFID tag codes of the electronic devices (510, 520), to form a list of the electronic devices. The controller 530 selects the electronic device to be controlled (510 or 520) from the list, and transmits signals to and receives signals with the RFID tag code from the transceiver of the electronic device and thereby wirelessly controls the electronic devices (510 and 520).

In addition, the signals of the present invention can use the industrial, scientific and medical bands (ISM bands, for example: 2.4 GHz) for transmission, because the bands have electromagnetic penetration, and the arrangement of the control units and the controller is more flexible as a result.

It will be apparent to those skilled in the art that various modifications and variations can be made to the structure of the present invention without departing from the scope or spirit of the invention. In view of the foregoing, it is intended that the present invention cover modifications and variations of this invention, provided that they fall within the scope of the following claims and their equivalents.

What is claimed is:

1. A system of RFID wireless control, comprising:
at least one electronic device having an RFID tag associated with an RFID tag code, and a first transceiver; and
a controller comprising a second transceiver and a reader for reading and recording the RFID tag code of the at least one electronic device, to form a list of electronic devices, the controller selecting one electronic device to be controlled from the list, transmitting to and receiving signals with the RFID tag code from the one electronic device by the second transceiver.

2. The system of claim 1, wherein the at least one electronic device further comprises a specified control unit with an RFID tag associated with an RFID code matching the at least one electronic device, and a third transceiver for transmitting to and receiving signals with the matching RFID tag code from the at least one electronic device to control the device.

3. The system of claim 1, wherein the signals can be operated within the range of the ISM radio bands.

4. The system of claim 1, wherein the controller is portable, and the specified unit is fixed.

5. The system of claim 1, wherein the controller further comprises a display.

6. The system of claim 1, wherein the list is displayed by a graphical interface.

7. The system of claim 1, wherein the controller comprises a programmable control procedure function.

8. The system of claim 1, wherein the specified control unit further comprises at least one sensor for sensing ambient environmental factors of the at least one electronic device, and automatically setting the at least one electronic device on the basis of the environmental factors.

9. The system of claim 1, wherein the at least one electronic device further comprises a wireless control solid state relay switch.

10. The system of claim 1, wherein the at least one electronic device comprises a bypass switch loop or a parallel switch control.

11. A method of RFID wireless control, applying to an RFID system, wherein the RFID system comprises at least one electronic device having an RFID tag associated with an RFID tag code, and a first transceiver, and a controller, the method comprising:
reading and recording the RFID tag code with a reader of the controller;
forming a list of electronic devices in the controller;
selecting one electronic device to be controlled from the list; and
transmitting to and receiving signals with the RFID tag code from the one electronic device with a second transceiver of the controller to control the one electronic device.

12. The method of claim 11, wherein the at least one electronic device further comprises a specified control unit with an RFID tag associated with an RFID tag code, matching the at least one electronic device, and a third transceiver for transmitting and receiving signals with the matching RFID tag code to control the at least one electronic device.

13. The method of claim 11, wherein the signals can be operated within the range of the ISM radio bands.

14. The method of claim 11, wherein the controller is portable, and the specified control unit is fixed.

15. The method of claim 11, wherein the controller comprises a display.

16. The method of claim 11, wherein the list is displayed by a graphical interface.

17. The method of claim 11, wherein the controller comprises a programmable control procedure function.

18. The method of claim 11, wherein the specified control unit further comprises at least one sensor for sensing ambient environmental factors of the at least one electronic devices, and automatically setting the at least one electronic device on the basis of the environmental factors.

19. The method of claim 11, wherein the first transceiver of the at least one electronic device further comprises a wireless control solid state relay switch.

20. The method of claim 11, wherein the at least one electronic device comprises a bypass switch loop or a parallel switch control.
